(19) United States
(12) Patent Application Publication
(10) Pub. No.: US 2023/0316173 A1
(43) Pub. Date: Oct. 5, 2023

(54) SYSTEMS AND METHODS FOR DATA ANALYTICS FOR AN AGRONOMY COMMUNITY

(71) Applicant: Nutrien AG Solutions, Inc., Loveland, CO (US)

(72) Inventors: Paul S. Miller, Champaign, IL (US); Patrick A. Morse, Duncansville, PA (US); Andrew Ayers, Champaign, IL (US); Joshua O'Neal, Monticello, IL (US)

(21) Appl. No.: 18/023,277

(22) PCT Filed: Aug. 26, 2021
(86) PCT No.: PCT/US2021/047721

§ 371 Date: Feb. 24, 2023

Related U.S. Application Data
(60) Provisional application No. 63/071,706, filed on Aug. 28, 2020.

(51) Int. Cl. G06Q 10/0631; G06Q 50/02

(52) U.S. Cl. CPC G06Q 10/06311; G06Q 50/02

(57) ABSTRACT

At least some embodiments of the present disclosure are directed to systems and methods for data analytics for a community and/or a campaign. In some cases, a process implemented by a data analytics system includes the steps of: providing an input data protocol to a plurality of data providers of a campaign; receiving a plurality of datasets from the plurality of data providers; processing the plurality of datasets to remove sensitive information contained in the plurality of agronomic datasets; aggregating the plurality of processed datasets to generate an aggregated dataset; and allowing a plurality of participants of the campaign to access the aggregated dataset.

### CROSS REFERENCE TO RELATED APPLICATION

This application claims priority to Provisional Application No. 63/071,706, filed Aug. 28, 2020, which is herein incorporated by reference in its entirety.

### TECHNICAL FIELD

The present disclosure relates to conducting data analytics and sharing data analytics results for a community or a campaign, specifically, for an agronomy community or campaign.

### BACKGROUND

A sustainability campaign for agriculture may include different types of participants, such as growers, crop consultants, sales, regional and national managers, and/or the like. Large amount of agronomic data is collected for a sustainability campaign. Sustainability campaign reporting has often been manually created because of the complexity and uncontrolled quality of data.

### SUMMARY

As recited in examples, Example 1 is a method implemented on a computer system having one or more processors and memories. The method includes the steps of: providing, by the one or more processors, an input data protocol to a plurality of data providers of a campaign; receiving, by the one or more processors, a plurality of agronomic datasets from the plurality of data providers, each agronomic dataset of the plurality of agronomic datasets using at least a part of the input data protocol; processing, by the one or more processors, the plurality of agronomic datasets to remove sensitive information contained in the plurality of agronomic datasets; aggregating, by the one or more processors, the plurality of processed agronomic datasets to generate an aggregated dataset; and allowing, by the one or more processors, a plurality of participants of the campaign to access the aggregated dataset.

Example 2 is the method of Example 1, further comprising: storing the plurality of agronomic datasets in the one or more memories.

Example 3 is the method of Example 2, further comprising: verifying, by the one or more processors, the plurality of agronomic datasets based on the input data protocol to determine whether each agronomic dataset of the plurality of agronomic datasets meets a predetermined criteria; and rejecting a respective agronomic dataset if the respective agronomic dataset does not meet the predetermined criteria.

Example 4 is the method of Example 3, wherein the storing the plurality of agronomic datasets comprises excluding the rejected respective agronomic dataset from storing in the one or more memories.

Example 5 is the method of Example 3, wherein the aggregating a plurality of agronomic datasets comprises excluding the rejected respective agronomic dataset from aggregation.

Example 6 is the method of any of the Examples 1-5, further comprising: transmitting, by the one or more processors, an invitation to a participant of the campaign, wherein the invitation includes access information to the aggregated dataset.

Example 7 is the method of any of the Examples 1-6, wherein the receiving a plurality of agronomic datasets comprises receiving at least one of the plurality of agronomic datasets via a software interface.

Example 8 is the method of any of the Examples 1-7, wherein at least one of the plurality of data providers receives an incentive.

Example 9 is the method of any of the Examples 1-8, wherein at least one of the plurality of data providers is a participant of the campaign with access to the aggregated dataset.

Example 10 is the method of any of the Examples 1-9, wherein the campaign comprises one or more regions, and wherein a region comprises one or more participants.

Example 11 is the method of any of the Examples 1-10, further comprising: filtering, by the one or more processors, the plurality of agronomic datasets by a criterion related to an objective of the campaign.

Example 12 is the method of Example 11, wherein the objective of the campaign is related to at least one of a crop, a pest, and a geographic location.

Example 13 is the method of any of the Examples 1-12, further comprising: receiving, by the one or more processors, one or more record links; wherein the allowing a plurality of participants of the campaign to access the aggregated dataset comprises allowing access to a subset of the aggregated dataset to a participant based on the retrieved one or more record links.

Example 14 is the method of any of the Examples 1-13, further comprising: receiving, by the one or more processors, a participation request to the campaign by a requester; receiving, by the one or more processors, one or more record links related to the requester; and granting, by the one or more processors, the requester an access to a subset of the aggregated dataset based on the retrieved one or more record links.

Example 15 is a method implemented on a computer system having one or more processors and memories. The method includes the steps of: forming, by the one or more processors, a community for a campaign, the community comprising a plurality of participants, at least one of the plurality of participants joining the community by an invitation; generating, by the one or more processors, an aggregated dataset based on a plurality of agronomic datasets; receiving, by the one or more processors, a plurality of record links representing relationships among a plurality of entities, each record link of the plurality of record links indicative of an association of two or more entities; generating, by the one or more processors, a subset of the aggregated dataset for a participant based on the plurality of record links, at least one of the plurality record links associated with the participant; and granting, by the one or more processors, an access to a respective subset of the aggregated dataset to a participant based on the plurality of record links.

Example 16 is the method of Example 15, wherein the respective subset of the aggregated dataset is the aggregated dataset.

Example 17 is the method of Example 15 or 16, wherein each record link of the plurality of record links comprises two identities of two respective entities, an association type and permission information.

Example 18 is the method of any of the Examples 15-17, further comprising: receiving, by the one or more processors, a participation request to the campaign by a requester; retrieving, by the one or more processors, one or more record links of the plurality of record links associated with the requester from the one or more memories; and granting, by the one or more processors, the requester an access to a subset of the aggregated dataset based on the retrieved one or more record links.

Example 20 is the method of any of the Examples 15-19, further comprising: receiving, by the one or more processors, the plurality of agronomic datasets from a plurality of data providers; wherein each agronomic dataset of the plurality of agronomic datasets comprises an identity of a respective data provider.

Example 21 is the method of any of the Examples 15-20, wherein the receiving the plurality of agronomic datasets comprises receiving at least one of the plurality of agronomic datasets via a software interface.

Example 22 is the method of Example 21, wherein at least one of the plurality of data providers receives an incentive.

Example 23 is the method of Example 21, wherein at least one of the plurality of data providers is a participant of the campaign with access to the aggregated dataset.

Example 24 is the method of Example 21, wherein the generating an aggregated dataset comprises anonymizing at least one of the plurality of agronomic datasets.

Example 25 is the method of Example 21, wherein the generating an aggregated dataset comprises anonymizing each agronomic dataset of the plurality of agronomic datasets.

Example 26 is the method of any of the Examples 15-25, further comprising: verifying, by the one or more processors, the plurality of agronomic datasets with an input data protocol to determine whether each agronomic dataset of the plurality of agronomic datasets meets a predetermined criteria; and rejecting a respective agronomic dataset if the respective agronomic dataset does not meet the predetermined criteria.

Example 27 is the method of Example 26, wherein the generating an aggregated dataset comprises excluding the rejected respective agronomic dataset from aggregation.

Example 28 is the method of any of the Examples 15-27, wherein the campaign comprises one or more regions, and wherein a region comprises one or more participants.

Example 29 is the method of any of the Examples 15-28, further comprising:

filtering, by the one or more processors, the plurality of agronomic datasets by a criterion related to an objective of the campaign.

Example 30 is the method of Example 29, wherein the objective of the campaign is related to at least one of a crop and a geographic location.

### BRIEF DESCRIPTION OF DRAWINGS

The accompanying drawings are incorporated in and constitute a part of this specification and, together with the description, explain the advantages and principles of the invention. In the drawings,

FIG. 1 depicts an illustrative system diagram of a community/campaign data analytics system, in accordance with certain embodiments of the present disclosure;

FIG. 2A depicts an illustrative flow diagram of data analytics for a community/campaign, in accordance with certain embodiments of the present disclosure;

FIG. 2B depicts another illustrative flow diagram of data analytics for a community/campaign, in accordance with certain embodiments of the present disclosure

FIG. 2C depicts an illustrative flow diagram of sharing data analytics results in a community/campaign, in accordance with certain embodiments of the present disclosure;

FIG. 2D depicts one illustrative flow diagram of data quality management for a community/campaign data analytics, in accordance with certain embodiments of the present disclosure;

FIG. 2E depicts one illustrative flow diagram of a data provider process for a community/campaign, in accordance with certain embodiments of the present disclosure.

FIG. 3A depicts one illustrative example of a graphical interface of managing users/participants commitments in a sustainability campaign;

FIG. 3B depicts one illustrative example of a graphical interface of reviewing data inputs;

FIG. 3C depicts one illustrative example of a graphical interface of providing feedback to a data provider;

FIG. 4 depicts an illustrative data diagram used in a community/campaign data analytics system, in accordance with certain embodiments of the present disclosure, and

FIG. 5 is an illustrative example of a data structure for granting access permissions to different roles.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, certain embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items, and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information.

To be able to meet customer needs for sustainability reporting, systems are designed and constructed to allow complex sharing using a platform integrating science, analytics, and anonymized sharing into an effective community/campaign data analytics system. In some embodiments, the data analytics system anonymizes data before or during data aggregation, for example, to enhance data security. In some embodiments, the data analytics system allows complex sharing based upon record links representing associations/relationships of entities.

The associations of the entities can be, for example, vendor-customer relationship, consultant-customer relationship, entities in a same geographical region, entities working on a same crop, entities associated with a same pest controller, entities sharing a same vendor, entities sharing a same consultant, campaign sponsor, third party campaign provider, campaign initiator, and/or the like. In some embodiments, the data analytics system uses an input data protocol, for example, to ensure data quality. In some cases, the data analytics system uses multiple layers of automatic and semi-automatic data review process to ensure data quality of input data, such that the quality of data analytics results can be improved. In some cases, the complex sharing is designed to allow certain automatic sharing such that the use of computing resources is reduced.

In some embodiments, the data analytics system forms and manages a community at least partially by invitations to participants and granting certain access within the community. As used herein, a community refers to data structure including data records representing the network structure of the community and data record representing the participants. In some cases, forming a community at least partially by invitations can improve the efficiency and reducing the network usage.

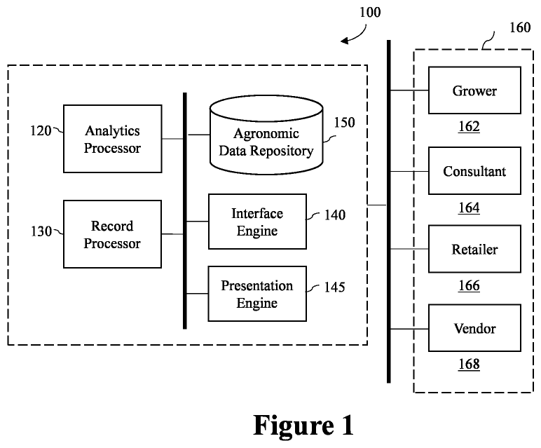

FIG. 1 depicts an illustrative system diagram of a community/campaign data analytics system 100, in accordance with certain embodiments of the present disclosure. As illustrated, the system 100 includes an analytics processor 120, a record processor 130, an interface engine 140, a presentation engine 145, and an agronomic data repository 150. One or more components of the system 100 are optional. In some cases, the system 100 can include additional components. In some cases, the system 100 interfaces with one or more third-party systems or other systems 160, for example, a grower data management system 162, a consultant data management system 164, a retailer data management system 166, a vendor data management system 168, and/or the like. In some cases, the community/campaign data analytics system 100 can interact with or be integrated into an agronomic management system. In some cases, various components of the community/campaign data analytics system 100 can be integrated with or use components (e.g., data analytics, user interface) of an agronomic management system. The agronomic management system can use, for example, aspects of a platform/system as described U.S. Patent Application No. 62/907,989, entitled “AGRICULTURE SERVICE PLATFORM,” the disclosure of which is hereby expressly incorporated herein by reference.

In some embodiments, the data analytics system 100 and/or the interface engine 140 provides an input data protocol to a plurality of data providers of a community/campaign. A community includes a group of participants with certain networking structures. In some cases, a community includes one or more regions, a region includes one or more members/participants, and each participant can have a respective participant type e.g., grower, consultant, retailer, etc.). In some cases, a participant is interested in a specific subset of information (e.g., a specific crop, a specific geographic location). In some embodiments, each participant has a participant profile represented by a data record, referred to as a participant profile record. As used herein, a campaign refers to a sequence of activities with a defined timelines within a time frame, where the campaign time frame has a start time and an end time. In some cases, the campaign is typically associated with a campaign objective such as, for example, improving crop growth efficiency, improving pest control efficiency, and/or the like.

In some cases, a community can include one or more campaigns. In some cases, a campaign can be held across one or more communities. Each campaign can have one or more input data protocols, for example, a grower data protocol, a consultant data protocol, a vendor data protocol, and/or the like. In some examples, a data protocol can include a list of data records, each data record including data fields, and each data field associated with a data type and/or a range. In some examples, a data protocol can specify what data fields are required and what data fields are optional. In some examples, the data protocol can specify what data fields are required in certain conditions such as, for example, an existence of a condition. In one example, the data protocol can require certain data fields if the grower's field within a specific geographic location.

In some embodiments, an organization or an entity is a company. In some cases, organizations interact with their customers through communities and an organization can have multiple communities. In some cases, a community is a group of users within an organization that all have a common relationship. For example, a group of customers all looking to purchase fertilizers would be a community. As another example, growers that are participating in a sustainability programs in the corn belt could be another community. In some cases, communities can be organized into regions or logical groupings of users, for example, to help make maintaining relationships with customers easier. In some cases, there are different types of communities, for example, sustainability communities, retailer communities, and general organizational communities.

In some cases, a campaign is a way of tracking seasonal activity of users within a community. In some cases, campaigns have defined timelines and data entry requirements with the end goal of providing reports/feedback to growers and organizations about agronomic practices. In one example, the sustainability programs use campaigns as a way of tracking improvement, providing advice to growers, and leveraging a consumer packaged goods company (CPG) purchasing power to ensure that grain is grown more efficiently. In such example, the CPG reporting deadlines and grower meetings dictate the timeline over which the campaign occurs.

In some cases, a region is a logical grouping of fields that are used to divide data up into analytical or statistical segments. Regions are often geospatial in nature (e.g., growers in central Illinois) but regions may be non-spatial (e.g., soybean growers managed by Fred). A community can have regions to help manage and organize growers. Campaigns can also have regions and while they can be inherited from the community or past campaigns, while campaign regions do not need to be identical to the community regions. In some cases, community regions and campaign regions are two different organizational groups that do not overlap.

In some cases, memberships describe how a user belongs to a community or a campaign. A user that is the member of a campaign should ideally be a member of the corresponding community, however community members may not have to be part of a campaign and users that are suspended from a community may still be part of inactive campaigns.

For an agronomy community/campaign, the data providers can be, for example, growers, consultants, retailers, vendors, and/or the like. In some embodiments, the data analytics system 100 and/or the interface engine 140 receives a plurality of agronomic datasets from the plurality of data providers. In some cases, some or all of the plurality of agronomic datasets are generated using at least a part of the input data protocol. In some cases, an agronomic dataset can be generated for an agronomic (e.g., crop) episode, which refers to a collection of agronomic conditions, for example, for a field. In some cases, the analytics processor 120 can verify the plurality of agronomic datasets with one or more input data protocols to determine whether each agronomic dataset of the plurality of agronomic datasets meets a predetermined criteria. In some cases, the predetermined criteria are campaign-specific, community-specific, and/or participant-specific. As used herein, a predetermined criteria refers to one or more sets of criteria. In some embodiments, a campaign can have one input data protocol with two or more sets of criteria (e.g., a criterion of a first set of required data fields, and a criterion of a second set of required data fields). In some cases, the predetermined criteria include different sets of criteria depending on different types of participants. In some cases, the predetermined criteria include different criteria depending on different geographic locations.

In some cases, one or more data providers receive an incentive to provide agronomic datasets according to an input data protocol and meeting the predetermined criteria, which is also referred to as a campaign commitment. In some embodiments, campaign commitments track the cropping episodes including one or more sets of agronomic data that have passed the requirements to participate in a campaign (year, crop, etc. . . . ) and have been submitted by the user for inclusion. These commitments are the basis of all sustainability data and allow managers to track progress and engagement. In some cases, the incentive can be, for example, a monetary incentive, an offer to one or more free services, a grant of access to aggregated dataset, and/or the like. In some cases, a grant of access to aggregated dataset, for example, using data from a plurality of data providers, is granted after the campaign commitment is met.

In some embodiments, the analytics processor 120 can reject an agronomic dataset if the agronomic dataset does not meet the predetermined criteria. In some cases, the rejected agronomic dataset is not store in the agronomic data repository 150 and/or not used in the data aggregation. In some embodiments, the analytics processor 120 can process the plurality of agronomic datasets to remove sensitive information contained in the plurality of agronomic datasets. In some cases, certain data fields are removed from the plurality of agronomic datasets. In some cases, the data in the data fields including sensitive information is substituted with other data, such that the data provider cannot be identified. For example, the data fields to be removed or anonymized include names and addresses. In some cases, the region information including, for example, city, state, country, is kept although the address is removed or substituted.

In some embodiments, the analytics processor 120 is configured to filter the plurality of agronomic datasets by a criterion related to an objective of the campaign. In some cases, the objective of the campaign is related to at least one of a crop, a pest, and a geographic location. In some embodiments, the analytics processor 120 can aggregate the plurality of processed agronomic datasets to generate an aggregated dataset. In some cases, the aggregated dataset includes analytics results such as, for example, a trend of crop efficiency. In some cases, the analytics processor 120 can extract trends across the campaign. The analytics processor 120 can use machine learning models including deep learning models, multidimensional analyses, and artificial intelligence systems to derive data indicating sustainability benefits from campaign data. Other crop and/or pest analytics can be done, for example, using aspects of a system as described in U.S. patent application Ser. No. 16/991,247, entitled “Pest and Agronomic Condition Prediction and Alerts Engine”, the content of which is incorporated by reference herein in its entirety.

In some embodiments, the data analytics processor 120 can use crop stressor variables in analyzing the agronomic datasets. In some cases, knowing practice details including the genetics of the crops grown, their agronomic management, and their sustainability analytics, all create a large collection of data. In some cases, the data analytics processor 120 can use various data analytics models including, for example, multivariate adaptive regression splines (MARS) modeling for prediction of land use, crop trend, energy metrics for fields, and/or the like. In some cases, the data analytics processor 120 can use deep learning models, which are trained on sustainability campaign data across crops and regions to aid in predicting not only sustainability metrics for uncharacterized areas but also for recommending the most efficient sustainability-based management approaches, crops, and climate risk management strategies. For example, the data analytics processor 120 can implement random forest models and other deep learning models for feature extraction (importance) and engineering (optimization) to understand the possibilities in managing complex agronomic systems for future climate scenarios. In many cases, the use of various data analytics models can improve the efficiency of computing resources in the data analytics system 100 and reduce the use of computing resources.

In some embodiments, the record processor 130 can allow a plurality of participants of the community/campaign to access the aggregated dataset or a subset of the aggregated dataset. In some cases, the record processor 130 is configured to send invitations to one or more participants to join the community and/or the campaign. In some cases, an invitation includes access information to the community/campaign. In some cases, the invitation includes login information to the community/campaign. In some cases, the invitation includes access information to the aggregated dataset or a subset of the aggregated dataset. In some cases, the invitation includes access information to allow access to a specific dataset (e.g., the aggregated dataset or a subset of the aggregated dataset) only.

In some cases, participants can be invited by many different parties working in concert as part of the community. In some cases, the record processor 130 and the system 100 allows participants to be recruited via invitation through a third-party sustainability software platform for the campaign sponsor. In one example, the invitation is an email with a code, where the participant can use the code to access campaign information and campaign results. In one example, the invitation is a published code allowing entities to access campaign information and campaign results if certain commitments are met. In another example, the record process 130 can analyze existing community members and invite those members meeting campaign criteria (e.g., a region, a crop). In some embodiments, at least one of the plurality of data providers is a participant of the campaign with access to the aggregated dataset or a subset of the aggregated dataset.

In some embodiments, a subset of an aggregated dataset can be generated and/or filtered using one or more of sustainability metrics including, for example, land use, energy use, green house gas emissions, soil loss, water quality, nitrogen use efficiency, and/or the like. In some embodiments, a subset of an aggregated dataset can be generated and/or filtered using grower data including, for example, field data, agronomic data for their fields, and/or the like. In some cases, data subsets are created by using the community permissions system to remove data that each individual user is not permitted to see. In many cases, generating a subset of aggregated dataset can improve the data security, where limited data is accessible.

In some embodiments, the record processor 130 is configured to retrieve one or more record links from the agronomic data repository 150. In some embodiments, each record link represents a relationship associated with two or more entities. In some cases, the record link is a part of a dataset associated with an entity such as, for example, a data provider and/or a participant of a community or campaign. In some embodiments, the record processor 130 is configured to generate a subset of the aggregated dataset based on the one or more record links associated with a participant. In some cases, the record processor 130 is further configured to grant an access to the subset of the aggregated dataset to the participant.

In some embodiments, the data analytics system 100 and/or the interface engine 140 receives a participation request to the campaign by a requester. In some cases, the participation request includes the requester's entity information. In some cases, the participation request is a confirmation of an invitation to the community/campaign sent to the requester. In some cases, the participation request is an acceptance to an incentive provided to a data provider. In some cases, the data provider is the requester. In some embodiments, the record processor 130 can retrieve one or more record links associated with the requester from the agronomic data repository 150. In some embodiments, the record processor 130 is configured to generate a subset of the aggregated dataset based on the one or more record links associated with the requester. In some cases, the record processor 130 is further configured to grant an access to the subset of the aggregated dataset to the requester.

In some embodiments, the interface engine 140 is configured to receive a plurality of agronomic datasets from a plurality of data providers (e.g., the grower 162, the consultant 164, the retailer 166, the vendor 168, etc.), In some embodiments, the interface engine 140 is configured to receive at least one of the plurality of agronomic datasets via a software interface. In some cases, the software interface comprises at least one of an application programming interface and a web service interface.

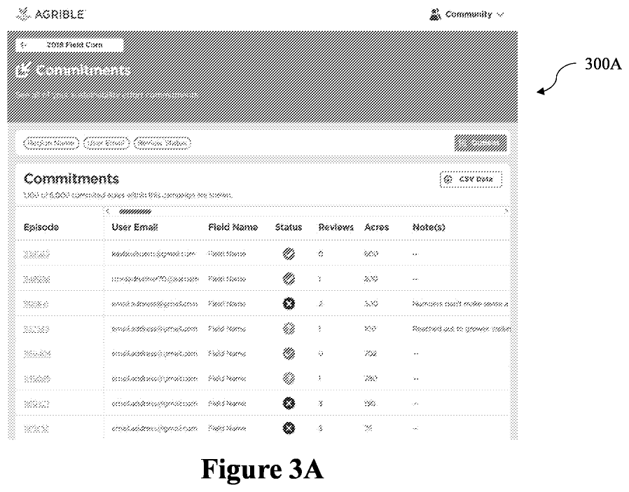

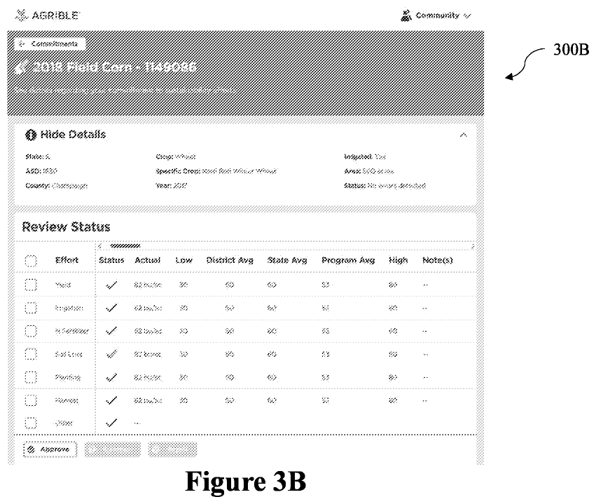

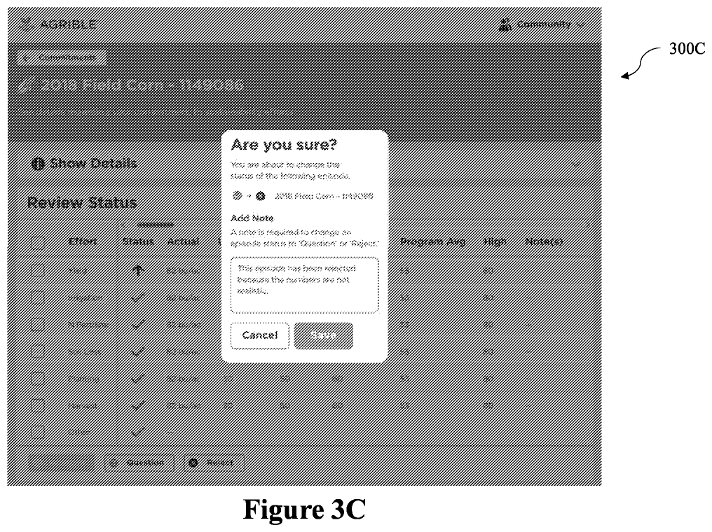

The presentation engine 145 is an optional component of the data analytics system 100. In some embodiments, the presentation engine 145 can be configured to render representations to users/participants/data providers. In some cases, the presentation engine 145 receives a type of a computing device (e.g., laptop, smart phone, tablet computer, etc.) being used and is configured to generate a graphical presentation adapted to the computing device type. In some embodiments, the presentation engine 145 can provide a graphical interface to receive user inputs, allow users to review data analytics results, and/or the like. In some cases, the presentation engine 145 can provide a graphical interface for community/campaign administrators to review data inputs, provide feedbacks, manage users/participants, manage invitations, and/or the like. FIG. 3A depicts one illustrative example of a graphical interface 300A of managing participant commitments. FIG. 3B depicts one illustrative example of a graphical interface 300B of reviewing data inputs. FIG. 3C depicts one illustrative example of a graphical interface 300C of providing feedbacks to a data provider.

In some embodiments, the agronomic data repository 150 can include agronomic datasets, anonymized agronomic datasets, aggregated agronomic datasets, input data protocols, and/or the like. The agronomic data repository 150 may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components of the system 100 can execute software or firmware stored in non-transitory computer-readable medium to implement various processing steps. Various components and processors of the system 100 can be implemented by one or more computing devices, including but not limited to, circuits, a computer, a cloud-based processing unit, a processor, a processing unit, a microprocessor, a mobile computing device, and/or a tablet computer. In some cases, various components of the system 100 (e.g., the analytics processor 120, the record processor 130, the interface engine 140, the presentation engine 150) can be implemented on a shared computing device. Alternatively, a component of the system 100 can be implemented on multiple computing devices. In some implementations, various modules and components of the system 100 can be implemented as software, hardware, firmware, or a combination thereof. In some cases, various components of the community/campaign data analytics system 100 can be implemented in software or firmware executed by a computing device.

Various components of the system 100 can communicate via or be coupled to via a communication interface, for example, a wired or wireless interface. The communication interface includes, but not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

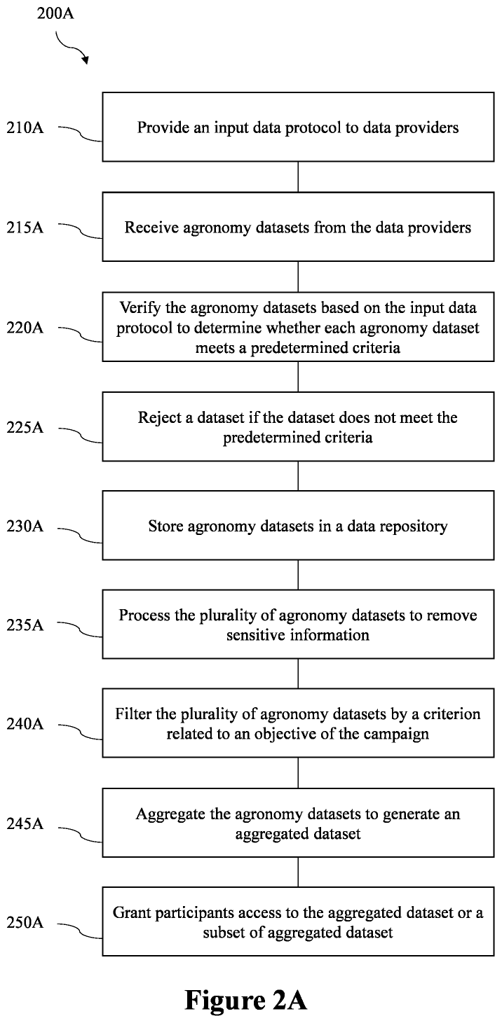

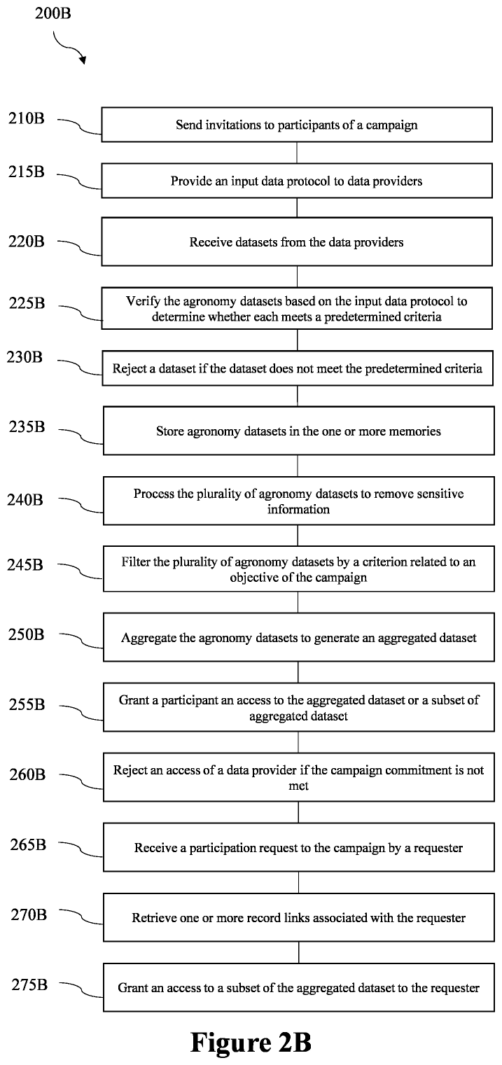

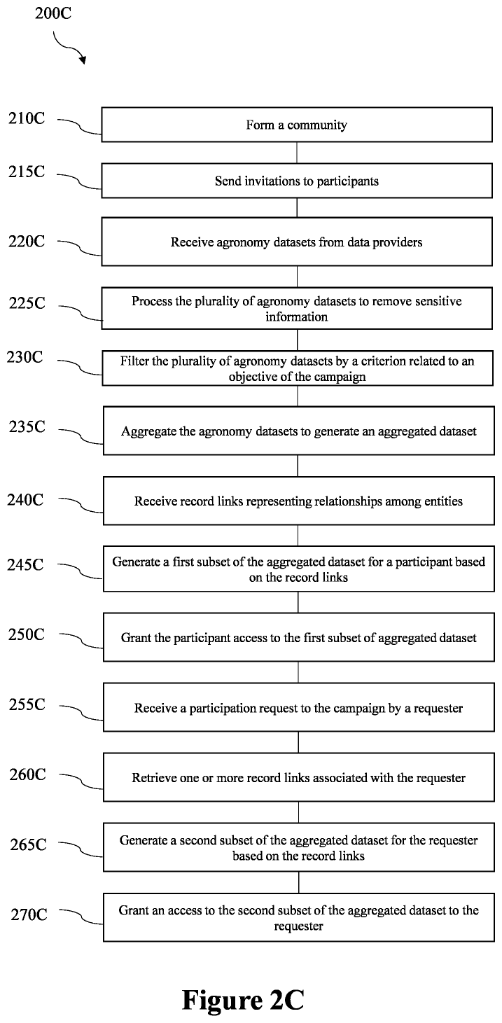

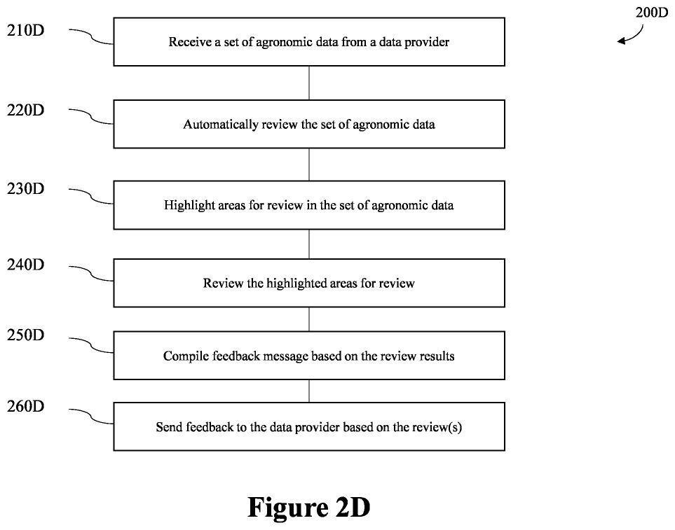

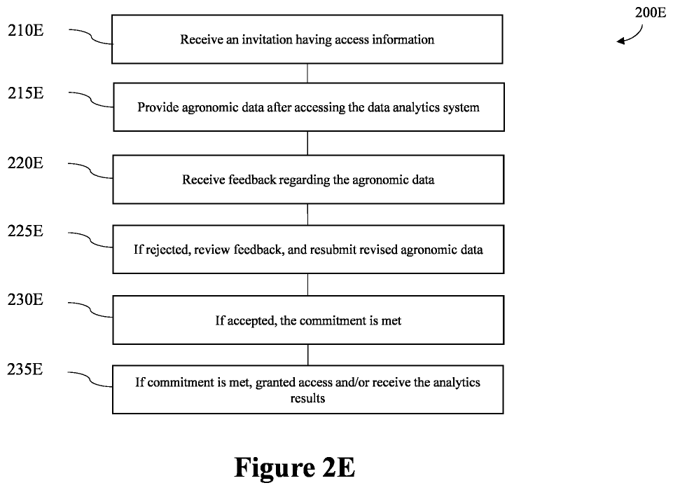

FIG. 2A depicts one illustrative flow diagram of data analytics for a community/campaign, in accordance with certain embodiments of the present disclosure. Aspects of embodiments of the method 200A may be performed, for example, by components of a data analytics system (e.g., components of the community/campaign data analytics system 100 of FIG. 1). One or more steps of method 200A are optional and/or can be modified by one or more steps of other embodiments described herein, Additionally, one or more steps of other embodiments described herein may be added to the method 200A, In some embodiments, the data analytics system provides an input data protocol to a plurality of data providers (210A), for example, for a campaign and/or a community. In some cases, the campaign/community is an agronomy campaign/community.

In some embodiments, a campaign includes a sequence of activities with a defined timelines within a time frame, where the campaign time frame has a start time and an end time. In some cases, the campaign is typically associated with a campaign objective such as, for example, improving crop growth efficiency, improving pest control efficiency, and/or the like. In some cases, a community can include two or more campaigns. In some cases, a campaign can be held across two or more communities. Each campaign can have one or more input data protocols, for example, a grower data protocol, a consultant data protocol, a vendor data protocol, and/or the like. In some examples, a data protocol can include a list of data fields, and each data field associated with a data type and/or a range. In some examples, a data protocol can specify what data fields are required and what data fields are optional. In some examples, the data protocol can specify what data fields are required in certain conditions such as, for example, an existence of a condition. In one example, the data protocol can require certain data fields if the grower's field within a specific geographic location.

For an agronomy community/campaign, the data providers can be, for example, growers, consultants, retailers, vendors, and/or the like. In some embodiments, the data analytics system receives a plurality of agronomic datasets from the plurality of data providers (215A). In some cases, some or all of the plurality of agronomic datasets are generated using at least a part of the input data protocol. In some cases, the data analytics system can verify the plurality of agronomic datasets with the input data protocol to determine whether each agronomic dataset of the plurality of agronomic datasets meets a predetermined criteria (220A). In some cases, the predetermined criteria is campaign-specific and/or community-specific. In some embodiments, a campaign can have one input data protocol with two or more sets of criteria. In some cases, the predetermined criteria include different sets of criteria depending on different types of users. In some cases, the predetermined criteria include different criteria depending on different geographic locations. In some cases, one or more data providers receive an incentive to provide agronomic datasets according to an input data protocol. In some cases, the incentive can be, for example, a monetary incentive, an offer to one or more free services, a grant of access to aggregated dataset, and/or the like.

In some embodiments, the data analytics system can reject an agronomic dataset if the agronomic dataset does not meet the predetermined criteria (225A), The system can store agronomic datasets in a data repository (e.g., the agronomic data repository 150 of FIG. 1) (230A). In some cases, the rejected agronomic dataset is not stored in the data repository and/or not used in the data aggregation. In some embodiments, the data analytics system can process the plurality of agronomic datasets to remove sensitive information (235A), for example, sensitive information and/or identifiable information contained in the plurality of agronomic datasets. In some cases, certain data fields are removed from the plurality of agronomic datasets. In some cases, the data in the data fields including sensitive information is substituted with other data, such that the data provider cannot be identified. For example, the data fields to be removed or anonymized include names and addresses. In some cases, the region information including, for example, city, state, country, is kept although the address is removed or substituted.

In some embodiments, the data analytics system is configured to filter the plurality of agronomic datasets by a criterion related to an objective of the campaign (240A). In some cases, the objective of the campaign is related to at least one of a crop, a pest, and a geographic location. In some embodiments, the data analytics system is configured to aggregate the agronomic datasets to generate an aggregated dataset (245A), In some cases, the agronomic datasets used in the aggregation only include filtered datasets. In some cases, the agronomic datasets used in the aggregation does not include rejected datasets. In some cases, the aggregated dataset includes analytics results such as, for example, a trend of crop efficiency.

In some embodiments, the data analytics system can grant participants of the community/campaign access to the aggregated dataset or a subset of the aggregated dataset (250A). In some cases, the data analytics system is configured to transmit invitations to one or more participants to join the community and/or the campaign. In some cases, an invitation includes access information to the community/campaign. In some cases, the invitation includes login information to the community/campaign. In some cases, the invitation includes access information to the aggregated dataset or a subset of the aggregated dataset. In some cases, the invitation includes access information to allow access to a specific dataset (e.g., the aggregated dataset or a subset of the aggregated dataset) only. In some embodiments, at least one of the plurality of data providers is a participant of the campaign with access to the aggregated dataset or a subset of the aggregated dataset,

FIG. 2B depicts one illustrative flow diagram of data analytics for a community/campaign, in accordance with certain embodiments of the present disclosure. Aspects of embodiments of the method 200B may be performed, for example, by components of a data analytics system (e.g., components of the community/campaign data analytics system 100 of FIG. 1). One or more steps of method 200B are optional and/or can be modified by one or more steps of other embodiments described herein, Additionally, one or more steps of other embodiments described herein may be added to the method 200B. In some embodiments, the community/campaign data analytics system is configured to send invitations to participants of a community/campaign (210B). In some cases, an invitation includes access information to the community/campaign. In some cases, the invitation includes login information to the community/campaign. In some cases, the invitation includes access information to some or all of data analytics results. In some cases, the invitation includes access information to allow access to a specific data analytic result but restricting access to any other data analytics results.

In some embodiments, the data analytics system provides a input data protocol to a plurality of data providers (215B), for example, for a campaign and/or a community. In some cases, the campaign/community is an agronomy campaign/community. In some embodiments, a campaign includes a sequence of activities with a defined timelines within a time frame, where the campaign time frame has a start time and an end time. In some cases, the campaign is typically associated with a campaign objective such as, for example, improving crop growth efficiency, improving pest control efficiency, and/or the like. In some cases, a community can include two or more campaigns. In some cases, a campaign can be held across two or more communities. Each campaign can have one or more input data protocols, for example, a grower data protocol, a consultant data protocol, a vendor data protocol, and/or the like. In some examples, a data protocol can include a list of data fields, and each data field associated with a data type and/or a range. In some examples, a data protocol can specify what data fields are required and what data fields are optional. In some examples, the data protocol can specify what data fields are required in certain conditions such as, for example, an existence of a condition. In one example, the data protocol can require certain data fields if the grower's field within a specific geographic location.

For an agronomy community/campaign, the data providers can be, for example, growers, consultants, retailers, vendors, and/or the like. In some embodiments, the data analytics system receives a plurality of agronomic datasets from the plurality of data providers (220B), In some cases, some or all of the plurality of agronomic datasets are generated using at least a part of the input data protocol. In some cases, the data analytics system can verify the plurality of agronomic datasets with the input data protocol to determine whether each agronomic dataset of the plurality of agronomic datasets meets a predetermined criteria (225B). In some cases, the predetermined criteria is campaign-specific and/or community-specific. In some embodiments, a campaign can have one input data protocol with two or more sets of criteria. In some cases, the predetermined criteria include different sets of criteria depending on different types of users. In some cases, the predetermined criteria include different criteria depending on different geographic locations. In some cases, one or more data providers receive an incentive to provide agronomic datasets according to an input data protocol. In some cases, the incentive can be, for example, a monetary incentive, an offer to one or more free services, a grant of access to aggregated dataset, and/or the like. In some embodiments, at least one of the plurality of data providers is a participant of the campaign with access to the aggregated dataset or a subset of the aggregated dataset. FIG. 3B depicts one illustrative example of a graphical interface 300B of reviewing data inputs.

In some embodiments, the data analytics system can reject an agronomic dataset if the agronomic dataset does not meet the predetermined criteria (230B). In some cases, each data provider has an assigned campaign commitment including, for example, submitting agronomic dataset met with the predetermined criteria. In some cases, a profile record associated with a data provider is updated after determining whether the submitted dataset meets the predetermined criteria. FIG. 3C depicts one illustrative example of a graphical interface 300C of providing feedbacks to a data provider. The system can store agronomic datasets in a data repository (e.g., the agronomic data repository 150 of FIG. 1) (235B).

In some cases, the rejected agronomic dataset is not stored in the data repository and/or not used in the data aggregation. In some embodiments, the data analytics system can process the plurality of agronomic datasets to remove sensitive information (240B), for example, sensitive information and/or identifiable information contained in the plurality of agronomic datasets. In some cases, certain data fields are removed from the plurality of agronomic datasets. In some cases, the data in the data fields including sensitive information is substituted with other data, such that the data provider cannot be identified. For example, the data fields to be removed or anonymized include names and addresses. In some cases, the region information including, for example, city, state, country, is kept although the address is removed or substituted.

In some embodiments, the data analytics system is configured to filter the plurality of agronomic datasets by a criterion related to an objective of the campaign (24513). In some cases, the objective of the campaign is related to at least one of a crop, a pest, and a geographic location. In some embodiments, the data analytics system is configured to aggregate the agronomic datasets to generate an aggregated dataset (250B). In some cases, the agronomic datasets used in the aggregation only include filtered datasets. In some cases, the agronomic datasets used in the aggregation does not include rejected datasets. In some cases, the aggregated dataset includes analytics results such as, for example, a trend of crop efficiency.

In some embodiments, the data analytics system can grant participants of the community/campaign access to the aggregated dataset or a subset of the aggregated dataset (255B). In some embodiments, the data analytics system is configured to retrieve one or more record links from the data repository. In some embodiments, each record link represents a relationship associated with two or more entities. In some cases, the record link is a part of a dataset associated with an entity such as, for example, a data provider and/or a participant of a community or campaign. In some embodiments, the data analytics system is configured to generate a subset of the aggregated dataset based on the one or more record links associated with a participant. In some cases, the data analytics system is further configured to grant an access to the subset of the aggregated dataset to the participant. In some embodiments, the data analytics system rejects an access of a data provider to the aggregated dataset or a subset if the campaign commitment is not net (260B). In one example, the data record associated with this data provider may include a label indicative of whether the campaign commitment is met. In such example, the data provider would be granted or denied access based on the label in the data record. In another example, the data provider can be provided with an access to the aggregated dataset or a subset of the aggregated dataset only after the campaign commitment is met.

In some embodiments, the data analytics system receives a participation request to the campaign by a requester (265B). In some cases, the participation request includes the requester's individual or entity information. In some cases, the participation request is a confirmation of an invitation to the community/campaign sent to the requester. In some cases, the participation request is an acceptance to an incentive provided to a data provider. In some cases, the data provider is the requester. In some embodiments, the data analytics system can retrieve one or more record links associated with the requester (270B), for example, from a data repository (e.g., the agronomic data repository 150 of FIG. 1) and/or a third-party system (e.g., the third-party systems 160 in FIG. 1). In some embodiments, the data analytics system is configured to generate a subset of the aggregated dataset based on the one or more record links associated with the requester. In some cases, the data analytics system is further configured to grant an access to the subset of the aggregated dataset to the requester (275B).

FIG. 2C depicts one illustrative flow diagram of sharing data analytics result among a, community/campaign, in accordance with certain embodiments of the present disclosure. Aspects of embodiments of the method 200C may be performed, for example, by components of a data analytics system (e.g., components of the community/campaign data analytics system 100 of FIG. 1). One or more steps of method 200C are optional and/or can be modified by one or more steps of other embodiments described herein. Additionally, one or more steps of other embodiments described herein may be added to the method 200C, In some embodiments, the data analytics system can form a community (210C), for example, for a campaign.

In some embodiments, the community/campaign data analytics system is configured to send invitations to participants of a community/campaign (215C). In some cases, an invitation includes access information to the community/campaign. In some cases, the invitation includes login information to the community/campaign. In some cases, the invitation includes access information to some or all of data analytics results. In some cases, the invitation includes access information to allow access to a specific data analytic result but restricting access to any other data analytics results.

In some embodiments, the data analytics system receives a plurality of agronomic datasets from the plurality of data providers (220C). For an agronomy community/campaign, the data providers can be, for example, growers, consultants, retailers, vendors, and/or the like. In some embodiments, the data analytics system can process the plurality of agronomic datasets to remove sensitive information (225C), for example, sensitive information and/or identifiable information contained in the plurality of agronomic datasets. In some cases, certain data fields are removed from the plurality of agronomic datasets. In some cases, the data in the data fields including sensitive information is substituted with other data, such that the data provider cannot be identified. For example, the data fields to be removed or anonymized include names and addresses. In some cases, the region information including, for example, city, state, country, is kept although the address is removed or substituted.

In some embodiments, the data analytics system is configured to filter the plurality of agronomic datasets by a criterion related to an objective of the campaign (230C). In some cases, the objective of the campaign is related to at least one of a crop, a pest, and a geographic location. In some embodiments, the data analytics system is configured to aggregate the agronomic datasets to generate an aggregated dataset (235C). In some cases, the agronomic datasets used in the aggregation only include filtered datasets. In some cases, the aggregated dataset includes analytics results such as, for example, a trend of crop efficiency.

In some embodiments, the data analytics system is configured to receive or retrieve one or more record links (240C), for example, from data repository (e.g., the agronomic data repository 150 in FIG. 1) and/or third-party system (e.g., third-party systems 160 of FIG. 1). In some embodiments, each record link represents a relationship associated with two or more entities. In some cases, the record link is a part of a dataset associated with an entity such as, for example, a data provider and/or a participant of a community or campaign. In some embodiments, the data analytics system is configured to generate a first subset of the aggregated dataset based on the one or more record links associated with a participant (245C).

In some cases, the first subset is generated based on geographic information of the participant. In some cases, the first subset is generated based on a type of crop included in the participant profile record. In some cases, the first subset is generated based on existing relationships (e.g., relationships with customers). In some cases, the first subset is generated based on an agronomic practice or a group of agronomic practices. In some cases, the first subset is generated based on sustainability metric values. In some cases, the first subset is generated based on agronomic system classifications such as irrigation status. In some cases, the first subset is generated based on some agronomic parameters of fields such as, for example, fertility levels, field soils, and/or the like. In some embodiments, the data analytics system can grant the participant an access to the first subset of the aggregated dataset (250C). In many cases, the use of record links can improve efficiency of the data analytics system.

In some embodiments, the data analytics system receives a participation request to the campaign by a requester (255C). In some cases, the participation request includes the requester's individual or entity information. In some cases, the participation request is a confirmation of an invitation to the community/campaign sent to the requester. In some cases, the data provider is the requester. In some embodiments, the data analytics system can retrieve one or more record links associated with the requester (260C), for example, from a data repository (e.g., the agronomic data repository 150 of FIG. 1) and/or a third-party system (e.g., the third-party systems 160 in FIG. 1). In some embodiments, the data analytics system is configured to generate a second subset of the aggregated dataset based on the one or more record links associated with the requester (265C). In one embodiment, the record links are only from the data repository. In some cases, the record links are from both the data repository and the third-party system(s). In some cases, the data analytics system is further configured to grant an access to the second subset of the aggregated dataset to the requester (270C),

FIG. 2D depicts one illustrative flow diagram of data quality management for a community/campaign data analytics, in accordance with certain embodiments of the present disclosure. Aspects of embodiments of the method 200D may be performed, for example, by components of a data analytics system (e.g., components of the community campaign data analytics system 100 of FIG. 1). One or more steps of method 200D are optional and/or can be modified by one or more steps of other embodiments described herein. Additionally, one or more steps of other embodiments described herein may be added to the method 200D. Initially, the data analytics system receives a set of agronomic data from a data provider (210D), for example, submitted manually or extracted from automated machine-based processes (e.g., via a software interface).

In some embodiments, the system automatically reviews the set of agronomic data (220D). In some cases, during the committing process, received agronomic data are automatically evaluated against agronomic and sustainability ranges assigned to the campaign. In some cases, a data pattern repeated data) is identified in the agronomic data and flagged as potential anomalous data. In some embodiments, the data analytics system can employ but data analytics to identify anomalous data or potentially anomalous data.

In some embodiments, the data analytics system can highlight and/or flag data or data areas for review in the set of agronomic data (230D). In some cases, human reviewer(s) or other integrated or interfaced software system can review the highlighted/flagged areas for review (240D). In some cases, the data analytics system, the human reviewer, and/or a third-party software may accept or reject the submitted data. In some cases, a rejection reason is provided with a rejection. In some cases, the review results, including automatic and/or manual review results, are stored in a data repository. In some cases, the record of the data provider is updated, for example, with a label indicating a commitment being met or a label indicating a commitment not met.

In some embodiments, the data analytics system may compile feedback message based on the review results (250D), In one embodiment, the feedback message may be generated in by a natural language generator. In some cases, the feedback message includes data showing the rejection status with a rejection reason so that the data provider can correct the mistake themselves or with aid from campaign personnel. In some embodiments, the data analytics system sends feedback to the data provider based on the review(s) (260D). In some cases, the feedback is sent by email and/or any other notification system. In some cases, the feedback is presented in a webpage accessed by the data provider and/or by an application (e.g., a mobile application) accessed by the data provider. In some cases, the multiple layers of data review process can improve the performance of the data analytics system.

FIG. 2E depicts one illustrative flow diagram of a data provider process for a community/campaign, in accordance with certain embodiments of the present disclosure. Aspects of embodiments of the method 200E may be performed, for example, by components of a data analytics system (e.g., components of the community/campaign data analytics system 100 of FIG. 1, a software application for a data provider, the grower system 162 of FIG. 1). One or more steps of method 200E are optional and/or can be modified by one or more steps of other embodiments described herein. Additionally, one or more steps of other embodiments described herein may be added to the method 200E. In some embodiments, the data provider component/system receives an invitation having access information (210E), for example, the join a community and/or a campaign.

In some cases, the data provider component/system can provide agronomic data after accessing the data analytics system (215E), for example, via a software interface or manually. In some embodiments, the data provider component/system receive feedback (e.g., feedback message) regarding the submitted agronomic data (220E). If the data is rejected, the data provider can optionally review feedback, revise the data according to the feedback, and resubmit revised agronomic data (225E). If the data is accepted, the commitment is met (230E). If commitment is met, the data provider or the data provider component is granted access and/or receive the analytics results (235E). In one embodiment, the analytics results include a sustainability report, for example, specifically generated for the data provider. In some cases, the data provider is a grower and the sustainability report includes a comparison of the grower's agronomic practice(s) and other growers' agronomic practice(s) (e.g., the agronomic practice norm).

### EXAMPLES

### Example A

In one example, a community/campaign data analytics system may invite growers to join a campaign and/or the community. In this example, grower selection criteria include: 1) within a region nearby a mill; and 2) with whom a consumer-packaged goods company sources spring wheat in the 2020 season. The input data protocol requires the input data of grower's agronomic management practices for fields sowed with spring wheat within the campaign's region nearby the processing mill. The analytics results include assessment of their sustainability metrics. Participated growers can review their field results in context of the campaign region and, in some cases, the entire campaign. The grower is compensated by committed agronomic data to the campaign measured by acreage, for example, at $1.50 per acre for those committed acres.

### Example B

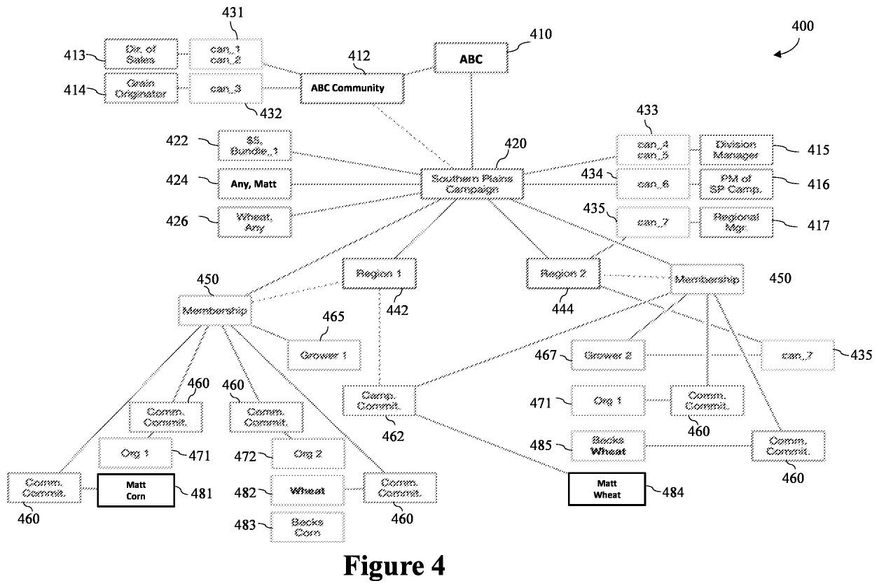

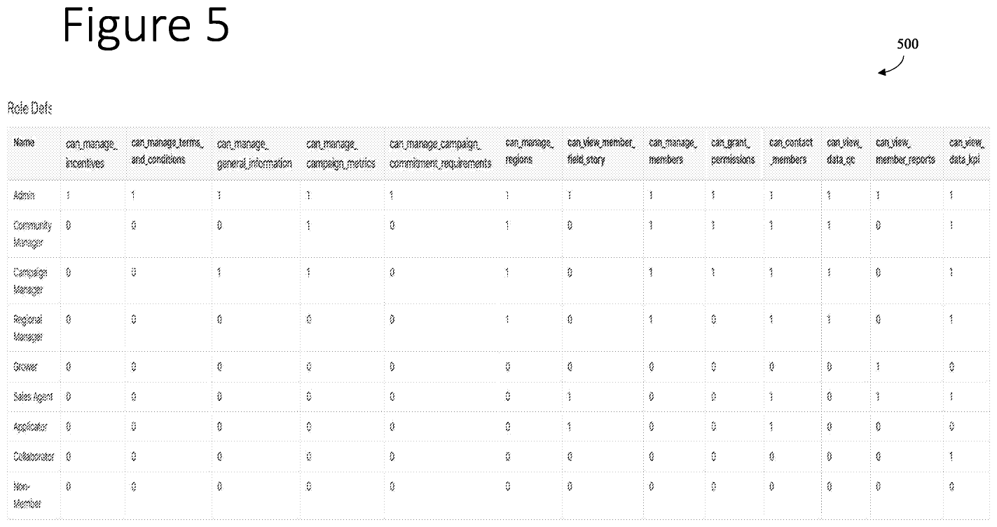

In this example, the community and campaign are formed within an organization. FIG. 4 depicts an illustrative data diagram 400 used in a community/campaign data analytics system, in accordance with certain embodiments of the present disclosure. In this example, the organization 410 forms a community 412 and a campaign 420. The data analytics system allows various types of users in the organization (e.g., a director of sales 413, a grain originator 414, a division manager 415, a campaign manager 416, and a regional manager 417), with each user/administrative user granted with a respective access permissions (e.g., 431, 432, 433, 434, 435). FIG. 5 is an illustrative example of respective access permissions granted to different roles.

In this example, the campaign 420 has one or more campaign requirements (e.g., 422, 424, 426) for submittals by growers, where the requirements include contract details for the campaign (e.g., the crop, the seed company, the compensation to the grower). These are also referred to as campaign characteristics. This campaign 420 is split into two regions, region 442 and region 444, for example, regions common for sourcing areas. Each region (e.g., 442, 444) has membership to those regional communities. Growers, grower 465 and grower 467, are members of communities and regions, commit data to a campaign, which is shared as needed via the data analytics system (e.g., the data analytics system 100, the presentation engine 145, and/or the interface engine 140 of FIG. 1). These data are then submitted to a quality assurance process built into the system for those who have permissions to correct data issues and document those corrections (not shown). These data are aggregated and anonymized, if needed, for the campaign 120.

In this example, the campaign is requesting sustainability data from any fields planted with seeds from company “Matt” or any wheat field cropping episodes for any seasons. This is an example showing the versatility of the system to be able to be configured for very different needs and reasons that are acutely intrinsic to agriculture. For these submitted data, the campaign is paying $5 per acre for committed field acres. These requirements are evaluated against when growers commit their data to the sustainability campaign. In this example, growers 465, 467 are linked to the community via membership, which can also optionally point to the region they are in. A user can have many organizations that they have access to via the data analytics system or any platform running the data analytics system. In some cases, a grower's organization 471 can have many fields with only some of those fields' sustainability data being committable to the community, where one or more community commitments 460 need to be met, or to the campaign, where one or more campaign commitments 462 need to be met. A user in the community means they have a membership and then their organization or organizations can be committed to a campaign. Once a grower's organization (e.g., organization 471, organization 472), is committed, field(s) from the organization can be committed with proper cropping episodes or seasons. This relationship facilitates selective visibility of a grower's data to be only what is shared to the community. In this example, field data and cropping episodes committed must meet campaign commitment requirements before they can be included in a campaign.

In this example, growers 465 and 467 have membership in the community 410 and the campaign 412. Grower 465 has membership in region 442 and grower 467 has membership in region 444. In this example, grower 465 and grower 467 have fields with different cropping episodes, for example, Matt corn episode 481, wheat episode 482, Becks corn episode 483, Matt wheat episode 484, and Becks wheat episode 485, where agronomic data for each episode can be submitted to the campaigns and regions as noted by linkage in the diagram.

### Example C

In this example, a consumer goods packaging company work with a sourcing company to create a campaign that sources hard winter wheat from two regions in the southern plains of the United States. The two primary regions are Western Kansas and Central Kansas. Ninety-one (91) growers are enrolled in the campaign and have submitted 240,000 acres to the campaign totaling 12 million bushels of wheat being processed.

In this example, the consumer goods packaging company is granted access to fully anonymized data from the campaign. They also are using the supply of grain to make their food products. In the data analytics system, the consumer goods packaging company only sees these fully processed and anonymized data for the individual regions. The sourcing company can have access to grower identifies information and actually compensates the growers for their submitted acreages per the agreement for submitting the sustainability analytics data. The sourcing company sources the grain directly from growers and processes it into ingredients for food products. In some cases, some members of the sourcing company are granted access to some of the details of the submitted agronomic episodes and may have worked with those growers on their input data ensuring any data issues might be resolved, while some other members of the sourcing company can only view processed and anonymized data.

Various modifications and alterations of this invention will be apparent to those skilled in the art without departing from the spirit and scope of this invention. The inventions described herein are not limited to the illustrative examples set forth herein. For example, the reader should assume that features of one disclosed example can also be applied to all other disclosed examples IC) unless otherwise indicated. It should also be understood that all U.S. patents, patent application publications, and other patent and non-patent documents referred to herein are incorporated by reference, to the extent they do not contradict the foregoing disclosure.

What is claimed is:

1. A method implemented on a computer system having one or more processors and memories, comprising:
providing, by the one or more processors, an input data protocol to a plurality of data providers of a campaign;
receiving, by the one or more processors, a plurality of agronomic datasets from the plurality of data providers, each agronomic dataset of the plurality of agronomic datasets using at least a part of the input data protocol;
processing, by the one or more processors, the plurality of agronomic datasets to remove sensitive information contained in the plurality of agronomic datasets;
aggregating, by the one or more processors, the plurality of processed agronomic datasets to generate an aggregated dataset; and
allowing, by the one or more processors, a plurality of participants of the campaign to access the aggregated dataset.

2. The method of claim 1, further comprising:
storing the plurality of agronomic datasets in the one or more memories.

3. The method of claim 2, further comprising:
verifying, by the one or more processors, the plurality of agronomic datasets based on the input data protocol to determine whether each agronomic dataset of the plurality of agronomic datasets meets a predetermined criteria; and
rejecting a respective agronomic dataset if the respective agronomic dataset does not meet the predetermined criteria.

4. The method of claim 3, wherein the storing the plurality of agronomic datasets comprises excluding the rejected respective agronomic dataset from storing in the one or more memories.

5. The method of claim 3, wherein the aggregating a plurality of agronomic datasets comprises excluding the rejected respective agronomic dataset from aggregation.

6. The method of claim 1, further comprising:
transmitting, by the one or more processors, an invitation to a participant of the campaign, wherein the invitation includes access information to the aggregated dataset.

7. The method of claim 1, wherein the receiving a plurality of agronomic datasets comprises receiving at least one of the plurality of agronomic datasets via a software interface.

8. The method of claim 1, wherein at least one of the plurality of data providers receives an incentive.

9. The method of claim 1, wherein at least one of the plurality of data providers is a participant of the campaign with access to the aggregated dataset.

10. The method of claim 1, wherein the campaign comprises one or more regions, and wherein a region comprises one or more participants.

11. The method of claim 1, further comprising:
filtering, by the one or more processors, the plurality of agronomic datasets by a criterion related to an objective of the campaign.

12. The method of claim 11, wherein the objective of the campaign is related to at least one of a crop, a pest, and a geographic location.

13. The method of claim 1, further comprising:
receiving, by the one or more processors, one or more record links;
wherein the allowing a plurality of participants of the campaign to access the aggregated dataset comprises allowing access to a subset of the aggregated dataset to a participant based on the retrieved one or more record links.

14. The method of claim 1, further comprising:
receiving, by the one or more processors, a participation request to the campaign by a requester;
receiving, by the one or more processors, one or more record links related to the requester; and
granting, by the one or more processors, the requester an access to a subset of the aggregated dataset based on the retrieved one or more record links.

15. A method implemented on a computer system having one or more processors and memories, comprising:
forming, by the one or more processors, a community for a campaign, the community comprising a plurality of participants, at least one of the plurality of participants joining the community by an invitation;
generating, by the one or more processors, an aggregated dataset based on a plurality of agronomic datasets;
receiving, by the one or more processors, a plurality of record links representing relationships among a plurality of entities, each record link of the plurality of record links indicative of an association of two or more entities;
generating, by the one or more processors, a subset of the aggregated dataset for a participant based on the plurality of record links, at least one of the plurality record links associated with the participant; and
granting, by the one or more processors, an access to a respective subset of the aggregated dataset to a participant based on the plurality of record links.

16. The method of claim 15, wherein the respective subset of the aggregated dataset is the aggregated dataset.

17. The method of claim 15, wherein each record link of the plurality of record links comprises two identities of two respective entities, an association type and permission information.

18. The method of claim 15, further comprising:
receiving, by the one or more processors, a participation request to the campaign by a requester;
retrieving, by the one or more processors, one or more record links of the plurality of record links associated with the requester from the one or more memories; and
granting, by the one or more processors, the requester an access to a subset of the aggregated dataset based on the retrieved one or more record links.

19. The method of claim 15, further comprising:
receiving, by the one or more processors, the plurality of agronomic datasets from a plurality of data providers;
wherein each agronomic dataset of the plurality of agronomic datasets comprises an identity of a respective data provider.

20. The method of claim 19, wherein the receiving the plurality of agronomic datasets comprises receiving at least one of the plurality of agronomic datasets via a software interface.

21. The method of claim 20, wherein at least one of the plurality of data providers receives an incentive.

22. The method of claim 20, wherein at least one of the plurality of data providers is a participant of the campaign with access to the aggregated dataset.

23. The method of claim 20, wherein the generating an aggregated dataset comprises anonymizing at least one of the plurality of agronomic datasets.

24. The method of claim 20, wherein the generating an aggregated dataset comprises anonymizing each agronomic dataset of the plurality of agronomic datasets.

25. The method of claim 15, further comprising:
verifying, by the one or more processors, the plurality of agronomic datasets with an input data protocol to determine whether each agronomic dataset of the plurality of agronomic datasets meets a predetermined criteria; and
rejecting a respective agronomic dataset if the respective agronomic dataset does not meet the predetermined criteria.

26. The method of claim 25, wherein the generating an aggregated dataset comprises excluding the rejected respective agronomic dataset from aggregation.

27. The method of claim 15, wherein the campaign comprises one or more regions, and wherein a region comprises one or more participants.

28. The method of claim 15, further comprising:
filtering, by the one or more processors, the plurality of agronomic datasets by a criterion related to an objective of the campaign.

29. The method of claim 28, wherein the objective of the campaign is related to at least one of a crop and a geographic location.
